(19) United States
(12) Patent Application Publication
(10) Pub. No.: US 2024/0363299 A1
(43) Pub. Date: Oct. 31, 2024

(54) CONTACTOR AND BATTERY PACK INCLUDING THE SAME

(71) Applicant: SAMSUNG SDI CO., LTD., Yongin-si (KR)

(72) Inventor: Sanghun JANG, Yongin-si (KR)

(21) Appl. No.: 18/451,659

(22) Filed: Aug. 17, 2023

(30) Foreign Application Priority Data
Apr. 25, 2023 (KR) 10-2023-0054246

(51) Int. Cl. H01H 50/54; H01M 10/42; H01M 50/296

(52) U.S. Cl. CPC H01H 50/54; H01M 10/425; H01M 50/296; H01M 2010/4271; H01M 2220/20

(57) ABSTRACT

A contactor includes: a first fixing contact terminal configured to be electrically connected to an energy storage device; a second fixing contact terminal configured to be electrically connected to a load; and a moving contact terminal configured to be releasably coupled to the first fixed contact terminal and the second fixed contact terminal according to a control signal. The first fixed contact terminal and the second fixed contact terminal are coupled to the moving contact terminal by a male-female coupling structure.

### CROSS-REFERENCE TO RELATED APPLICATION

This application claims priority and benefits of Korean Patent Application No. 10-2023-0054246, filed on Apr. 25, 2023, in the Korean Intellectual Property Office, the entire content of which is incorporated herein by reference.

### BACKGROUND

### 1. Field

Aspects of embodiments of the present disclosure relate to a contactor and a battery pack including the same.

### 2. Description of Related Art

A contactor is a device that acts as a switch to supply high voltage from a battery inside a battery pack to, for example, an electric vehicle. The contactor may include two fixing contact terminals and one moving contact terminal inside the contactor, and the moving contact terminal can be operated (or moved) upwardly by electromotive force applied to a coil. A battery management system (BMS) may command (e.g., control) the contactor, and a lead-acid battery may supply power to the coil.

If the BMS is reset for some reason while the vehicle is moving (e.g., is being driven), the contactor momentarily opens, and in this case, the vehicle cannot be driven (e.g., the vehicle's motors lose power). Accordingly, the battery pack include a retention circuit to maintain the contactor in a closed state even during a reset situation of the BMS for a certain (e.g., predetermined) time. However, if the lead-acid battery that powers the contactor and maintains it in the closed state by the retention circuit operation is unstable or experiences decreased power output, the power that supports the moving contact terminal in the contactor decreases, the fixing contact terminals and the moving contact terminal separate, and power may cut off in spite of the retention circuit. As a result, the vehicle cannot be driven.

### SUMMARY

Embodiments of the present disclosure provide a contactor and a battery pack including the same configured to maintain the contactor in a closed (or closing) state even if relatively low voltage is supplied to the contactor or if the power supply to the contactor is cut off while the contactor is closed (e.g., is in the closed state).

A contactor, according to an embodiment, includes: a first fixing contact terminal configured to be electrically connected to an energy storage device; a second fixing contact terminal configured to be electrically connected to a load; and a moving contact terminal configured to be releasably coupled to the first fixed contact terminal and the second fixed contact terminal according to a control signal. The first fixed contact terminal and the second fixed contact terminal are coupled to the moving contact terminal by a male-female coupling structure.

The first fixing contact terminal and the second fixing contact terminal may each have fitting grooves configured to accommodate the moving contact terminal, and the fitting grooves may extend in a longitudinal direction of the moving contact terminal.

The moving contact terminal may include a first protrusion and a second protrusion respectively protruding to correspond to positions of the first fixing contact terminal and the second fixing contact terminal, and the first fixing contact terminal and the second fixing contact terminal may each have a fitting groove configured to respectively accommodate the first and second protrusions therein.

The first fixing contact terminal and the second fixing contact terminal may include a first protrusion and a second protrusion protruding, respectively. The moving contact terminal may have a first fitting groove and a second fitting groove configured to respectively accommodate the first protrusion and the second protrusion and may be respectively aligned with positions of the first protrusion and the second protrusion.

The first fixing contact terminal and the second fixing contact terminal may include a first protrusion and a second protrusion protruding, respectively, and the moving contact terminal may have a fitting groove configured to accommodate the first protrusion and the second protrusion in a longitudinal direction.

The contactor may further include: a first contactor coil configured to move the moving contact terminal to be coupled with the first fixing contact terminal and the second fixing contact terminal according to a contactor close signal of the control signal; and a second contactor coil configured to move the moving contact terminal to be separated from the first fixing contact terminal and the second fixing contact terminal according to a contactor open signal of the control signal.

The moving contact terminal may be configured to move in a vertical direction and may be configured to be releasably coupled to the first fixing contact terminal and the second fixing contact terminal.

The moving contact terminal may be configured to move in a horizontal direction and may be configured to be releasably coupled to the first fixing contact terminal and the second fixing contact terminal.

A battery pack, according to an embodiment, includes a battery module, a contactor connected between the battery module and a load and including any of the above-described features, and a battery management system configured to control the contactor based on a state of the battery module.

### BRIEF DESCRIPTION OF THE DRAWINGS

FIG. 1 is a diagram schematically illustrating a battery pack according to an embodiment.

FIG. 2 is a diagram schematically illustrating a conventional contactor.

FIG. 3 is a diagram schematically illustrating a contactor according to an embodiment.

FIG. 4 to FIG. 7 are diagrams showing a male-female coupling structure of fixing contact terminals and a moving contact terminal shown in FIG. 3 according to different embodiments.

### DETAILED DESCRIPTION

Hereinafter, embodiments of the present disclosure will be described in detail with reference to the attached drawings such that that a person of ordinary skill in the art may easily implement the present disclosure. As those skilled in the art would realize, these embodiments may be modified in various different ways, all without departing from the spirit or scope of the present disclosure. Thus, the drawings and description are to be regarded as illustrative in nature and not restrictive. In any description of a method or steps of an operation, the order of operations (or of steps thereof) may be changed, several operations may be merged, some operations may be divided, and specific operations may not be performed.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

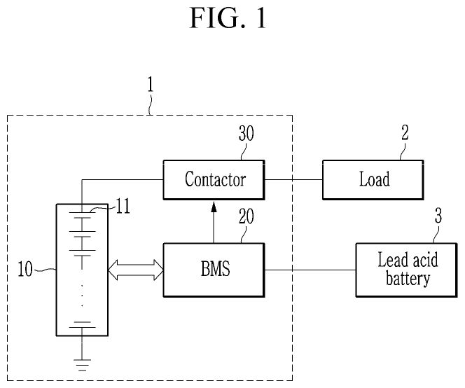

FIG. 1 is a diagram schematically illustrating a battery pack according to an embodiment.

Referring to FIG. 1, the battery pack 1 may be mounted in various power devices that use electrical energy stored in the battery pack 1, such as an electric vehicle.

The battery pack 1 may include at least one battery module 10, a battery management system (BMS) 20, and a contactor 30.

The battery module 10 may include a plurality of battery cells 11 electrically connected to each other in series and/or in parallel.

The BMS 20 may control and manage overall operations of the battery pack 1. The BMS 20 monitors the overall state (e.g., voltage, current, and temperature) of the battery module 10 and the battery cells 11 included in the battery module 10 and perform various control functions (e.g., charging, discharging, balancing) to adjust the state of the battery module 10 and the battery cells 11.

The contactor 30 may be connected between the positive terminal of the battery module 10 and a load 2 and operates by receiving power from (e.g., is powered by) a lead acid battery 3.

The contactor 30 may be switched to an open state or a closed state according to (e.g., in response to) a control signal from the BMS 20. For example, the contactor 30 may be switched to an open state according to an open control signal from (e.g., received from) the BMS 20. When the contactor 30 is in the open state, no electrical connection exists between the battery module 10 and the load 2 and power from the battery module 10 is not supplied to the load 2 (e.g., the battery module 10 and the load 2 are electrically disconnected from each other). In addition, the contactor 30 may be switched to a closed state according to a closed control signal from (e.g., received from) the BMS 20. When the contactor 30 is in the closed state, the battery module 10 and the load 2 are electrically connected to each other and power from the battery module 10 may be supplied to the load 2.

The lead acid battery 3 may be a 12 volt battery. The lead acid battery 3 may be, for example, a battery used in vehicles (e.g., a starter battery or accessory battery in a vehicle).

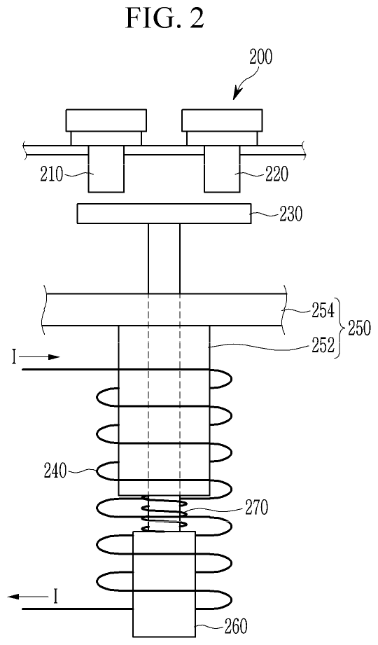

FIG. 2 is a diagram schematically illustrating a conventional contactor.

Referring to FIG. 2, a conventional contactor 200 may include two fixing contact terminals 210 and 220, a moving contact terminal 230, and a contactor coil 240.

The fixing contact terminal 210 may be electrically connected to a positive terminal of a battery module.

The fixing contact terminal 220 may be electrically connected to a load.

The contactor coil 240 may be mounted in a form surrounding (e.g., may be coiled around) a first fixing jig 252 and a moving structure 260. The fixing jig 250 may include the first fixing jig 252 and a second fixing jig 254. The first fixing jig 252 and the second fixing jig 254 have holes (e.g., openings) formed therein, respectively, so that the moving structure 260 can move in a vertical direction through the inside of the first fixing jig 252 and the second fixing jig 254. The first fixing jig 252 and the second fixing jig 254 are coupled together, and the second fixing jig 254 may be fixed to one side inside a housing surrounding an outside of the contactor 200. One side of the moving structure 260 may be coupled to the moving contact terminal 230.

When power is supplied to the contactor coil 240 according to a contactor closed signal from a BMS, a current I may flow through the contactor coil 240. Due to the current I, the moving structure 260 may move upwardly according to the principle of an electromagnet following Fleming's right-hand rule, and the fixing contact terminals 210 and 220 and the moving contact terminal 230 are coupled to (e.g., are brought into contact with) each other so that the contactor 200 is in a closed state. Conversely, when the power supply to the contactor coil 240 is cut off according to a contactor open signal from the BMS, the current I does not flow through the contactor coil 240. Then, the moving structure 260 moves downwardly due to the force of an elastic spring 270 such that the fixing contact terminals 210 and 220 and the moving contact terminal 230 may be separated from each other, transitioning the contactor 200 in an open state.

While the contactor 200 is in the closed state according to the contactor close signal from the BMS, a lead acid battery powering the contactor 200 may be discharged and output a relatively low voltage of only several volts (e.g., a relatively low voltage of less than 12 volts). In this case, the force pushing (or holding) the moving structure 260 up becomes weaker and the force of the elastic spring 270 may overcome the force from the current I passing through the contactor coil 240 such that the fixing contact terminals 210 and 220 and the moving contact terminal 230 may separate and the contactor 200 may open (e.g., may transition to the open state). In this case, power is not supplied to from the battery module to the load and, in the case of an electric vehicle, driving becomes impossible.

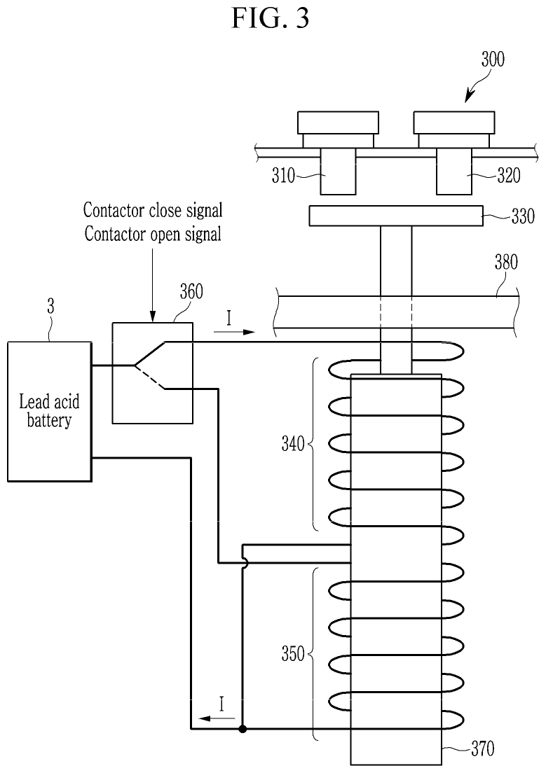

According to embodiments of the present disclosure, when the contactor 30 is in the closed state according to the contactor close signal from the BMS 20, the contactor 30 does not open (e.g., does not transition to the open state) even if the lead acid battery 3 is discharged and a relatively low voltage is applied to the contactor coil. The contactor 30 will be described in more detail with reference to FIG. 3.

FIG. 3 is a diagram schematically illustrating a contactor according to an embodiment.

Referring to FIG. 3, the contactor 300, which is an embodiment of the contactor 30 shown in FIG. 1, may include two fixing contact terminals 310 and 320, a moving contact terminal 330, and two contactor coils. The two contactor coils may include an upper contactor coil 340 and a lower contactor coil 350. The contactor 300 may further include a switch 360.

One terminal of the switch 360 may be connected to the positive terminal of the lead acid battery 3, and the other terminal of switch 360 may be connected to one terminal of the upper contactor coil 340 or one terminal of the lower contactor coil 350. The other terminal of the upper contactor coil 340 and the other terminal of the lower contactor coil 350 may be connected to the negative terminal of the lead acid battery 3.

The upper contactor coil 340 and the lower contactor coil 350 may be wound around the moving structure 370. The upper contactor coil 340 may be wound around a top (e.g., a top or upper end) of the moving structure 370, and the lower contactor coil may be wound around a bottom (e.g., a bottom or lower end) of the moving structure 370. Winding directions of the upper contactor coil 340 and the lower contactor coil 350 may be opposite directions.

The moving structure 370 may move in a vertical direction through the hole (e.g., opening) in the fixing jig 380 according to (e.g., in response to) power applied to the upper contactor coil 340 or the lower contactor coil 350.

The switch 360 may connect the other terminal of the switch 360 to one end of the upper contactor coil 340 according to a contactor close signal from the BMS 20. Thus, the switch 360 may apply power from the lead acid battery (see, e.g., 3 in FIG. 1) to the upper contactor coil 340 according to the contactor close signal from the BMS (see, e.g., 20 in FIG. 1).

The switch 360 may connect the other terminal of the switch 360 to one end of the lower contactor coil 350 according to the contactor open signal from the BMS 20. That is, the switch 360 may apply power from the lead acid battery 3 to the lower contactor coil 350 according to the contactor open signal.

When power is supplied to the upper contactor coil 340 from the lead acid battery 3, a current I may flow through the upper contactor coil 340, and thus, the moving structure 370 may move upwardly according to the principle of an electromagnet following Fleming's right-hand rule. Thus, the fixing contact terminals 310 and 320 and the moving contact terminal 330 may be coupled to each other such that the contactor 300 is in the closed state.

In contrast, when power is supplied to the lower contactor coil 350 from the lead acid battery 3, a current I may flow through the lower contactor coil 350, and accordingly, the moving structure 370 may move downwardly according to the principle of an electromagnet following Fleming's right-hand rule. Thus, the fixing contact terminals 310 and 320 and the moving contact terminal 330 may separate from each other such that that the contactor 300 is in (e.g., transitions into) the open state.

In this way, the contactor 300, according to an embodiment, uses the lower contactor coil 350, which is wound in the opposite direction with respect to the upper contactor coil 340, to lower the moving structure 370. Accordingly, the elastic spring 270 shown in FIG. 2. can be omitted.

Furthermore, the fixing contact terminals 310 and 320 and the moving contact terminal 330 of the contactor 300, according to an embodiment, may have male-female coupling structure. Because the fixing contact terminals 310 and 320 and the moving contact terminal 330 have the male-female coupling structure, when the contactor close signal from the BMS 20 is applied, the fixing contact terminals 310 and 320 and the moving contact terminal 330 can maintain a more stable and robust coupling state.

That is, when the BMS 20 commands the contactor 300 to close, even if the lead acid battery 3 is discharged and a relatively low voltage is applied to the upper contactor coil 340, and the force pushing the moving structure 370 upwardly is weaker, but the coupled state between the fixing contact terminals 310 and 320 and the moving contact terminal 330 may be maintained by the force of the physical male-female coupling between the fixing contact terminals 310 and 320 and the moving contact terminal 330.

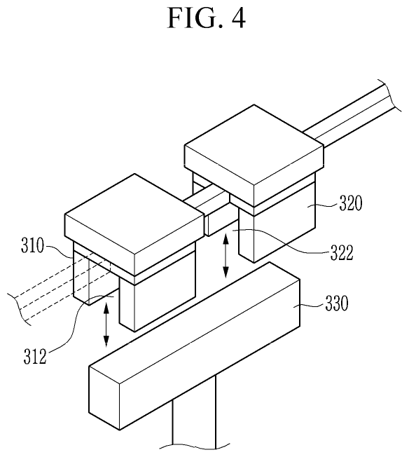

FIG. 4 to FIG. 7 are diagrams showing male-female coupling structures of the fixing contact terminals and the moving contact terminal shown in FIG. 3 according to different embodiments.

Referring to FIG. 4, the fixing contact terminals 310 and 320 may respectively have fitting grooves 312 and 322 formed therein, which are accommodating spaces having a depth for accommodating the moving contact terminal 330. The fitting grooves 312 and 322 may be formed in the longitudinal direction of the moving contact terminal 330.

The moving contact terminal 330 may have a width that can fit into the fitting grooves 312 and 322 formed in the fixing contact terminals 310 and 320.

According to the contactor close signal, the moving contact terminal 330 may be inserted into the fitting grooves 312 and 322 in the fixing contact terminals 310 and 320, and the fixing contact terminals 310 and 320 and the moving contact terminal 330 may be coupled (connected) together.

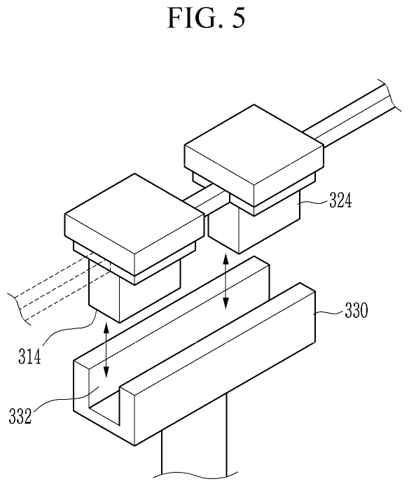

Referring to FIG. 5, different from FIG. 4, the moving contact terminal 330 may have a fitting groove 332, which is an accommodation space, formed in the longitudinal direction. Further, the fixing contact terminals 310 and 320 may respectively have protrusions 314 and 324 protruding in the vertical direction to be inserted into the fitting groove 332. The widths of the protrusions 314 and 324 may be the same as that of the fitting groove 332 (e.g., to provide a force-fit connection).

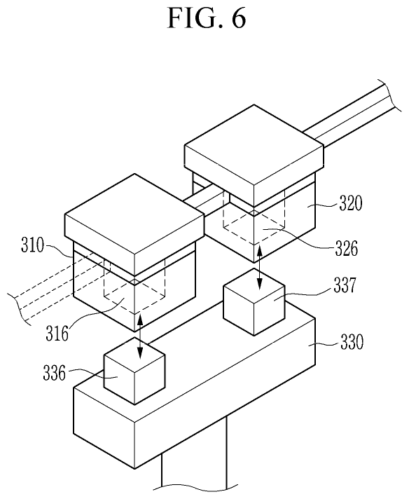

In response to the contactor close signal, the fitting groove 332 formed in the moving contact terminal 330 may surround the protrusions 314 and 324 respectively formed on the fixing contact terminals 310 and 320, and the fixing contact terminals 310 and 320 and the moving contact terminal 330 may be coupled (connected) thereto. Next, referring to FIG. 6, the fixing contact terminals 310 and 320 may have fitting grooves 316 and 326, respectively, and the moving contact terminal 330 may have protrusions 336 and 337 protruding in a vertical direction corresponding to (e.g., aligned with) positions of the fitting grooves 316 and 326 formed in the fixing contact terminals 310 and 320.

In response to the contactor close signal, the protrusions 336 and 337 of the moving contact terminal 330 may be respectively inserted into the fitting grooves 316 and 326 in the fixing contact terminals 310 and 320, and the fixing contact terminals 310 and 320 and the moving contact terminal 330 may be coupled (connected) together.

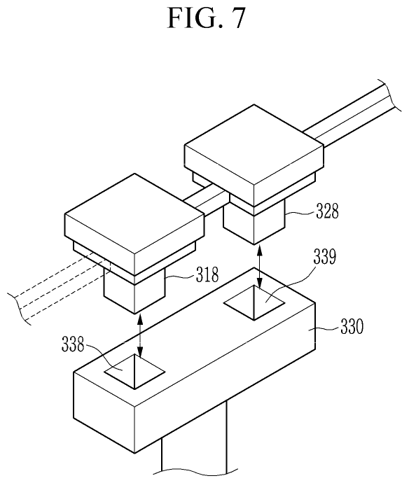

Referring to FIG. 7, different from FIG. 6, the fixing contact terminals 310 and 320 may respectively have protrusions 318 and 328 protruding in a vertical direction, and the moving contact terminal 330 may have fitting grooves 338 and 339 formed corresponding to (e.g., aligned with) the positions of the protrusions 318 and 328 so that the protrusions 318 and 328 may be inserted therein.

In response to the contactor close signal, the fitting grooves 338 and 339 in the moving contact terminal 330 may surround the protrusions 318 and 328 formed on the fixing contact terminals 310 and 320, and the fixing contact terminals 310 and 320 and the moving contact terminal 330 may be coupled (connected) together.

In the male-female coupling structure of the fixing contact terminals 310 and 320 and the moving contact terminal 330 described with reference to FIGS. 4 to 7, in response the contactor close signal of the BMS 20, even if the lead acid battery 3 is discharged and a relatively low voltage is applied to the upper contactor coil 340, the coupled (closed) state between the fixing contact terminals 310 and 320 and the moving contact terminal 330 may be maintained.

In addition, the male-female coupling structure of the fixing contact terminals 310 and 320 and the moving contact terminal 330 respectively described with reference to FIGS. 4 to 7 may be applied to the vertical driving method by the upper and lower contactor coils 340 and 350 described above but may also be applied to the contactor having horizontal driving type (or horizontal driving direction) that operates on the principle that the moving contact terminal 330 moves in the horizontal direction and may be coupled to or separated from the fixing contact terminals 310 and 320 according to the contactor close signal and the contactor open signal.

According to embodiments of the present disclosure, even if a lead acid battery supplying power to the contactor is discharged or if the lead acid battery is unstable, the contactor terminal may be maintained in the closed state. Thus, it is possible to continuously supply power from the battery pack to the load and to prevent arcing due to instantaneous opening and closing of the contactor.

In addition, if the fixing contact terminals and the moving contact terminal are weakly (or partially) welded together due to arcing inside the contactor, the weld may be released (or broken) by a downwardly pulling force when the contactor open command is received.

Although embodiments of the present disclosure have been described in detail above, the scope of the present disclosure is not limited thereto. Various modifications and improvements made by those skilled in the art based on the basic concept of the present disclosure, as defined in the following claims and their equivalents, are also included in the scope of the present disclosure.

Description of Some Reference Numerals

| | |
|---|---|
| 1: battery pack | 2: load |
| 3: lead acid battery | 10: battery module |
| 20: BMS | 30, 300: contactor |
| 200: conventional contactor | 210, 220, 310, 320: fixing contact |
| | terminal |
| 230: 330: moving contact terminal | 340: upper contactor coil |
| 350: lower contactor coil | 360: switch |
| 370: moving structure | 380: fixed jig |

What is claimed is:

1. A contactor comprising:
a first fixing contact terminal configured to be electrically connected to an energy storage device;
a second fixing contact terminal configured to be electrically connected to a load; and
a moving contact terminal configured to be releasably coupled to the first fixed contact terminal and the second fixed contact terminal according to a control signal,
wherein the first fixed contact terminal and the second fixed contact terminal are coupled to the moving contact terminal by a male-female coupling structure.

2. The contactor as claimed in claim 1, wherein the first fixing contact terminal and the second fixing contact terminal each have fitting grooves configured to accommodate the moving contact terminal, the fitting grooves extending in a longitudinal direction of the moving contact terminal.

3. The contactor as claimed in claim 1, wherein the moving contact terminal comprises a first protrusion and a second protrusion respectively protruding to correspond to positions of the first fixing contact terminal and the second fixing contact terminal, and
wherein the first fixing contact terminal and the second fixing contact terminal each have a fitting groove configured to respectively accommodate the first and second protrusions therein.

4. The contactor as claimed in claim 1, wherein the first fixing contact terminal and the second fixing contact terminal comprise a first protrusion and a second protrusion protruding, respectively, and
wherein the moving contact terminal has a first fitting groove and a second fitting groove configured to respectively accommodate the first protrusion and the second protrusion and being respectively aligned with positions of the first protrusion and the second protrusion.

5. The contactor as claimed in claim 1, wherein the first fixing contact terminal and the second fixing contact terminal comprise a first protrusion and a second protrusion protruding, respectively, and
wherein the moving contact terminal has a fitting groove configured to accommodate the first protrusion and the second protrusion in a longitudinal direction.

6. The contactor as claimed in claim 1, further comprising:
a first contactor coil configured to move the moving contact terminal to be coupled with the first fixing contact terminal and the second fixing contact terminal according to a contactor close signal of the control signal; and
a second contactor coil configured to move the moving contact terminal to be separated from the first fixing contact terminal and the second fixing contact terminal according to a contactor open signal of the control signal.

7. The contactor as claimed in claim 1, wherein the moving contact terminal is configured to move in a vertical direction and is configured to be releasably coupled to the first fixing contact terminal and the second fixing contact terminal.

8. The contactor as claimed in claim 1, wherein the moving contact terminal is configured to move in a horizontal direction and is configured to be releasably coupled to the first fixing contact terminal and the second fixing contact terminal.

9. A battery pack comprising:
a battery module;
the contactor according to claim 1, the contactor being connected between the battery module and the load; and
a battery management system configured to control the contactor based on a state of the battery module.
